(19) United States
(12) Patent Application Publication
(10) Pub. No.: US 2007/0008168 A1
(43) Pub. Date: Jan. 11, 2007

(54) [WIRELESS REMOTE CONTROLLER]

(75) Inventors: Wen-Sheng Liao, TAIPEI (TW); Yu-Hsin Wu, TAIPEI (TW); Sheng-Nan Lin, TAIPEI (TW); Chao-Wu Chien, TAIPEI (TW)

Correspondence Address: RAYTAC CORP., P.O. BOX 108-00403, TAIPEI, TW

(73) Assignee: RAYTAC CORP., Chung Ho, Taipei Hsien (TW)

(21) Appl. No.: 11/160,771

(22) Filed: Jul. 8, 2005

(51) Int. Cl. H04Q 7/00

(52) U.S. Cl. 340/825.69; 348/734; 398/106

(57) ABSTRACT

A wireless remote controller includes a transmitter unit, which has a data storage device with an Express Card interface connectable to a main system directly for enabling the main system to store data into or fetch data from a flash memory of the data storage device, and a control device with operating buttons and a transmitting antenna, and a receiver unit, which is receivable in an open chamber of the housing of the transmitter unit when not in use and has a USB interface for connection to the main system for receiving control signals from the transmitter unit and transmitting received control signals to the connected main system.

### BACKGROUND OF THE INVENTION

1. Field of the Invention

The present invention relates to a wireless remote controller and more particularly, to such a wireless remote controller, which is made to fit Express Card specifications and has memory means for data access.

2. Description of the Related Art

Many people tend to use a desktop computer or notebook computer for making a brief presentation, or as an entertainment platform for playing video games, watching DVD, or listening music. When a computer is used for making a brief presentation or executing a multimedia function, a wireless remote controller may be necessary for controlling the operation of the computer conveniently at a distance. The wireless receiver unit and wireless transmitter (control) unit of a conventional wireless remote controller are two separate members. The user may forget where the wireless transmitter is.

Further, following fast development of data storage and access technology, a variety of mobile memory devices have been developed and have appeared on the market. However, a wireless remote controller and a mobile memory device are two different separate items, not attachable together. Because these mobile devices are compact and small, the user may lose the devices and forget where they are.

It is desirable to have a combination electronic device, which has a wireless remote controller and a data storage device incorporated therein to extend product utilization and to save the manufacturing cost.

### SUMMARY OF THE INVENTION

The present invention has been accomplished under the circumstances in view. It is one object of the present invention to provide a wireless remote controller, which is convenient to carry. It is another object of the present invention to provide a wireless remote controller, which prevents missing of the receiver unit when not in use. It is still another object of the present invention to provide a wireless remote controller, which provides an added data storage function. It is still another object of the present invention to provide a wireless remote controller, which saves much manufacturing cost. According to one aspect of the present invention, the wireless remote controller is comprised of a transmitter (control) unit, and a receiver unit. The wireless remote controller is made subject to Express Card specifications for insertion into an Express Card slot. According to another aspect of the present invention, the transmitter unit has an open chamber in the housing thereof for accommodating the receiver unit, allowing insertion of the whole assembly into an Express Card slot. According to still another aspect of the present invention, the transmitter unit has incorporated therein a data storage device so that the main system to which the wireless remote controller is connected can store data into or fetch data from the data storage device. According to still another aspect of the present invention, the control device and the data storage device of the transmitter unit uses the same housing, saving much manufacturing cost.

### BRIEF DESCRIPTION OF THE DRAWINGS

FIG. 1 illustrates the outer appearance of a wireless remote controller according to the present invention.

FIG. 2 shows the receiver unit separated from the transmitter unit according to the present invention.

FIG. 3 is a system block diagram of the present invention.

FIG. 4A is a circuit diagram of the data storage device according to the present invention.

FIGS. 4B and 4C together form a circuit diagram of the data storage device according to the present invention.

FIGS. 5A, 5B and 5C together form a circuit diagram of the control device according to the present invention.

FIG. 5D is a diagram showing how FIGS. 5A, 5B and 5C mate together.

FIG. 5E is a circuit diagram of the control device according to the present invention.

FIG. 6A is a circuit diagram of the receiver unit according to the present invention.

FIGS. 6B, 6C, 6D, 6E, 6F and 6G together form a circuit diagram of the receiver unit according to the present invention.

FIG. 6H is a diagram showing how FIGS. 6B, 6C, 6D, 6E, 6F and 6G mate together.

FIG. 6I is a circuit diagram of the receiver unit according to the present invention.

FIG. 7 is a schematic drawing show a status of use of the present invention.

FIG. 8 is a schematic drawing showing another status of use of the present invention.

### DETAILED DESCRIPTION OF THE PREFERRED EMBODIMENT

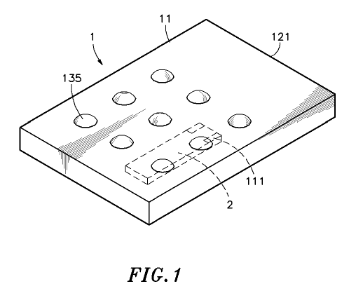

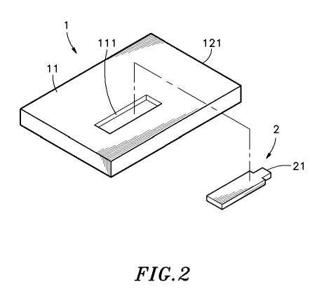

Referring to FIGS. 1˜7, a wireless remote controller in accordance with the present invention is shown comprised of a transmitter unit (control unit) 1, and a receiver unit 2.

The transmitter unit 1 comprises a housing 11, which has an open chamber 111 adapted to accommodate the receiver unit 2 when not in use, a data storage device 12 and a control device 13 mounted in the housing 11. The data storage device 12 comprises a Express Card interface 121 defined subject to PCMCIA (Personal Computer Memory Card International Association), a flash memory control chip 122 electrically connected to the Express Card interface 121, and a flash memory 123 electrically connected to the flash memory control chip 122. The control device 13 comprises a micro-controller 131, a battery 132 electrically connected to the micro-controller 131 to provide the necessary working voltage, a RF (Radio Frequency) circuit 133 electrically connected to the micro-controller 131, an indicator light 134 electrically connected to the micro-controller 131, a set of operating buttons 135 respectively electrically connected to the micro-controller 131, a transmitting antenna 136 electrically connected to the RF circuit 133, and a sensor 137 electrically connected to the micro-controller 131.

The Express Card interface 121 is provided at one side of the housing 11 for connection to a main system (for example, a notebook computer) 3.

Through the Express Card interface 121, the flash memory control chip 122 stores data from the main system 3 into the flash memory 123, or fetches data from the flash memory 123 and then transmits fetched data to the main system 3.

The micro-controller 131 receives signal produced by the operating buttons 135 and proceeds with the related processing subject to the content of the signal from the operating buttons 135.

The RF circuit 133 receives signal provided by the micro-controller 131, and modulates the signal to a predetermined frequency for transmitting to the outside through the transmitting antenna 136.

The indicator light 134 is turned on to give a visual indication signal subject to the control of the micro-controller 131 during operation of the control device 13.

The operating buttons 135 are mounted in the outside wall of the housing 11. The user can operate each operating button 135 to produce a respective signal to the micro-controller 131 for further processing.

The transmitting antenna 136 is adapted to transmit signal from the RF circuit 133 to the receiver unit 2 by radio.

The sensor 137 may be mounted inside or outside the housing 11 to produce a corresponding control signal to the micro-controller 131 for further processing subject to the user's command or external environmental change (such as pressure or temperature).

The receiver unit 2 is comprised of an USB (Universal Serial Bus) interface 21, a micro controller 22, a RF circuit 23, a receiving antenna 24, and an indicator light 25.

The USB interface 21 is connectable to the main system 3.

The micro-controller 22 is adapted to receive signal from the RF circuit 23 and transmits the signal to the main system 3 through the USB interface 21.

The RF circuit 23 is adapted to demodulate signal received from the receiving antenna 24 and to transmit the demodulated signal to the micro-controller 22.

The receiving antenna 24 is adapted to receive modulated signal from the transmitting antenna 136 and transmits received signal to the RF circuit 23.

The indicator light 25 is turned on to give a visual indication signal when the micro-controller 22 receives a signal from the receiving antenna 24 through the RF circuit 23.

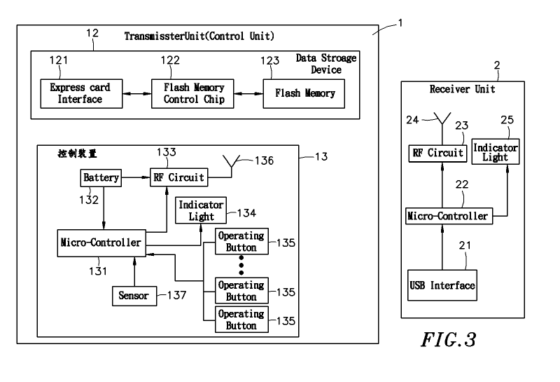

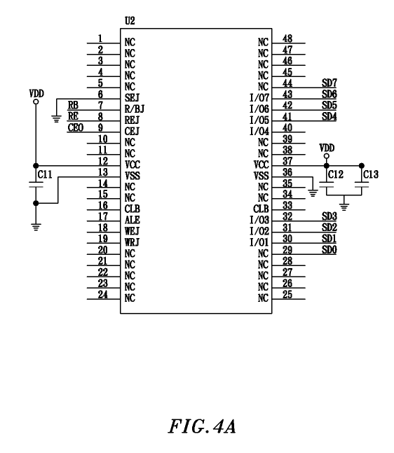

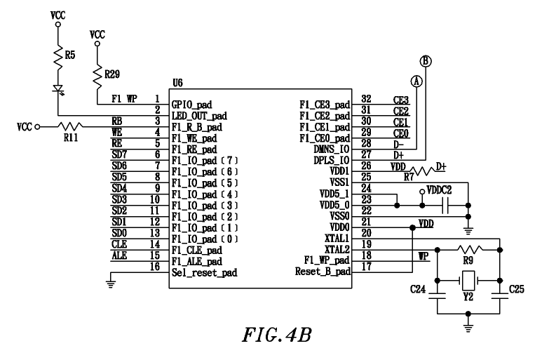

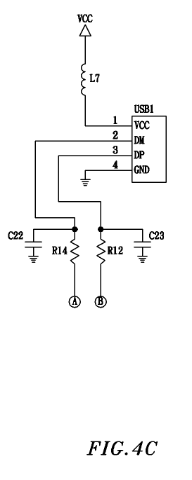

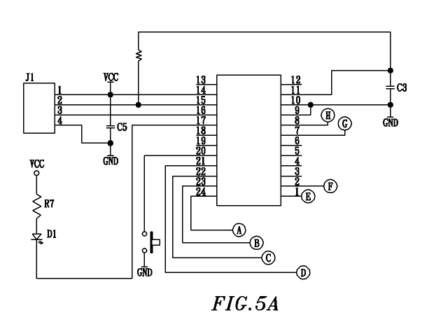

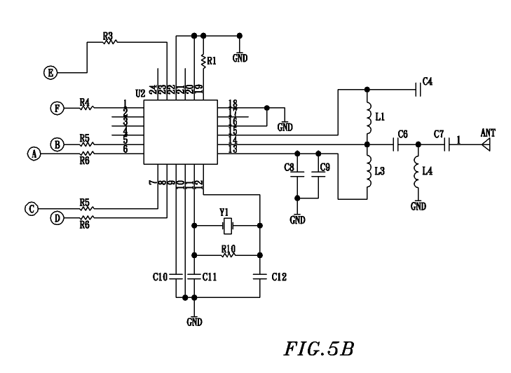

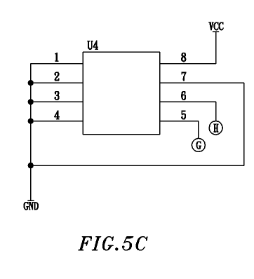

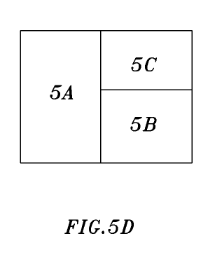

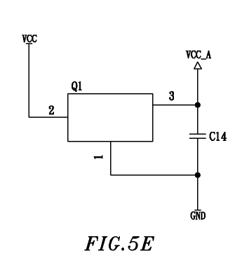

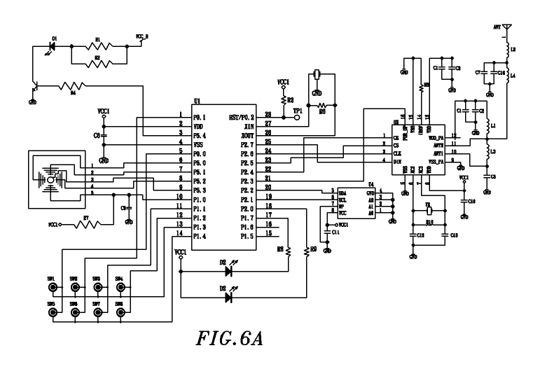

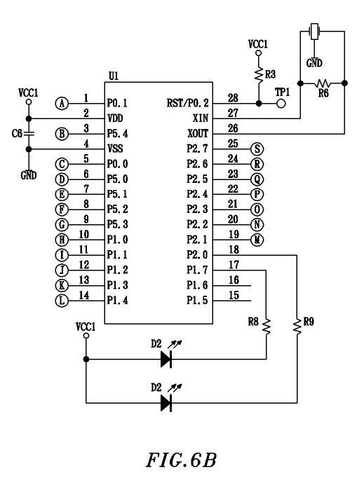

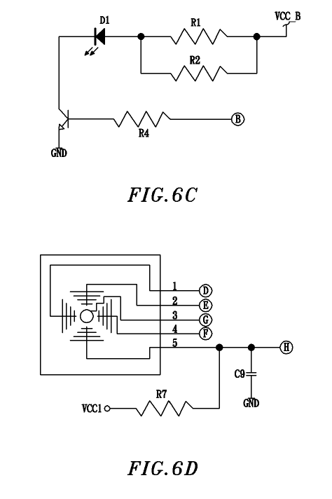

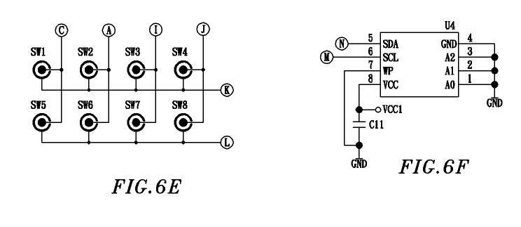

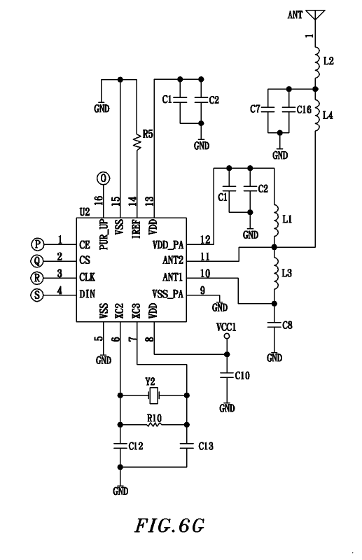

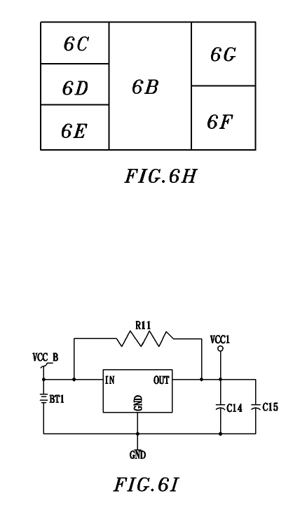

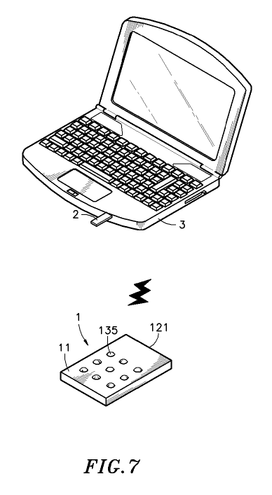

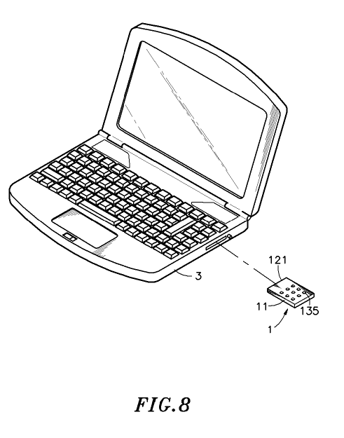

Referring to FIGS. 1, 3 and 7 again, when using the invention to control the operation of the main system 3, connect the USB interface 21 of the receiver unit 2 to one USB port of the main system 3, for enabling the receiver unit 2 to receive the necessary working voltage from the main system 3 through the USB interface 21. At this time, the user can use the operating buttons 135 of the control device 13 to control the operation of the main system 3. When the user clicked on operating button 135 or when the sensor 137 is induced, a corresponding signal is produced and sent to the micro-controller 131. Upon receive of the signal, the micro-controller 131 produces a corresponding control signal to the RF circuit 133, which in turn modulates the control signal and transmits the modulated control signal to the receiving antenna 24 of the receiver unit 2 through the transmitting antenna 136. Upon receipt of the modulated control signal, the receiving antenna 24 transmits the modulated control signal to the RF circuit 23, which demodulates the control signal and then transmits the demodulated control signal to the micro-controller 22, enabling the micro-controller 22 to transmit the control signal to the main system 3 through the USB interface 21.

Further, when the user operates the operating buttons 135 of the control device 13 to control the operation of the main system 3, the indicator light 134 is turned on to give a visual indication signal.

Further, the main system 3 can be a desktop computer, notebook computer, or digital TV; the indicator lights 134 and 25 can be LEDs (light emitting diodes) or laser diodes.

Referring to FIG. 8 and FIGS. 1 and 3 again, when the Express Card interface 121 of the transmitter unit 1 is electrically connected to the main system 3, the transmitter unit 1 obtains the necessary working voltage from the main system 3 through the Express Card interface 121. When the user operates the main system 3 to give a instruction to store data into or fetch data from the transmitter unit 1, the instruction will be sent through the Express Card interface 121 to the flash memory control chip 122, causing the flash memory control chip 122 to store data into the flash memory 123, or to fetch data from the flash memory 123 and then sends the fetched data to the main system 3.

As indicated above, the wireless remote controller of the present invention has the following features.

1. When not in use, the receiver unit 2 can be received in the open chamber 111 in the housing 11 of the transmitter unit 1, preventing missing of the receiver unit 2.

2. Through the Express Card interface 121, the transmitter unit 1 can be electrically connected to the main system 3 for enabling the main system 3 to store data into or fetch data from the flash memory 123 of the transmitter unit 1.

3. The data storage device 12 and the control device 13 use the same housing 11, saving much manufacturing cost.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A wireless remote controller used with a main system, comprising a transmitter unit and a receiver unit, wherein:
said transmitter unit comprises a housing, said housing comprising an open chamber adapted to accommodate said receiver unit, a data storage device mounted inside said housing for storing data, and a control device mounted inside said housing and operable by the user to produce a control signal, said data storage device comprising an Express Card interface electrically connectable to said main system, a flash memory, and a flash memory control chip electrically connected between said Express Card interface and said flash memory, said control device comprising a micro-controller, a plurality of operating buttons mounted in an outside wall of said housing and respectively electrically connected to said micro-controller of said control device for operation by the user to produce a respective control signal to said micro-controller of said control device, and a transmitting antenna electrically connected to said micro-controller of said control device for transmitting control signals from said operating buttons to said receiver unit subject to the control of said micro-controller of said control device;
said receiver unit comprises a USB (Universal Serial Bus) interface connectable to said main system, a receiving antenna adapted to receive control signals from said transmitter unit, and a micro-controller adapted to transmit control signals received from said receiving antenna to said main system through said USB interface.

2. The wireless remote controller as claimed in claim 1, wherein said control device further comprises a battery electrically connected to said micro-controller thereof.

3. The wireless remote controller as claimed in claim 1, wherein said control device further comprises an indicator light electrically connected to said micro-controller thereof and adapted to give off light upon operation of said control device.

4. The wireless remote controller as claimed in claim 3, wherein said indicator light is a light emitting diode.

5. The wireless remote controller as claimed in claim 3, wherein said indicator light is a laser diode.

6. The wireless remote controller as claimed in claim 1, wherein said control device further comprises sensor means electrically connected to said micro-controller thereof and adapted to detect an environmental status and to produce a control signal to said micro-controller of said control device upon change of the environmental status.

7. The wireless remote controller as claimed in claim 1, wherein said control device further comprises a RF (Radio Frequency) circuit electrically connected between said micro-controller of said control device and said transmitting antenna for modulating signals subject to a predetermined frequency.

8. The wireless remote controller as claimed in claim 1, wherein said receiver unit further comprises a RF (Radio Frequency) circuit electrically connected between said micro-controller of said receiver unit and said receiving antenna and adapted to demodulate control signals received by said receiving antenna.

9. The wireless remote controller as claimed in claim 1, wherein said receiver unit further comprises an indicator light electrically connected to said micro-controller of said receiver unit adapted to give off light upon operation of said receiver unit.

10. The wireless remote controller as claimed in claim 1, wherein said main system is a desktop personal computer.

11. The wireless remote controller as claimed in claim 1, wherein said main system is a notebook computer.

12. The wireless remote controller as claimed in claim 1, wherein said main system is a digital TV.
